(19) United States
(12) Patent Application Publication
(10) Pub. No.: US 2011/0170180 A1
(43) Pub. Date: Jul. 14, 2011

(54) ELECTROSTATIC DEFORMABLE MIRROR USING UNITARY MEMBRANE

(76) Inventors: Kevin Thomas Turner, Madison, WI (US); Max G. Lagally, Madison, WI (US)

(21) Appl. No.: 12/027,726

(22) Filed: Feb. 7, 2008

(51) Int. Cl. G02B 21/06; G02B 5/08; B23P 19/00

(52) U.S. Cl. 359/385; 359/846; 29/426.1

(57) ABSTRACT

A deformable mirror for an adaptive optical system employs a thin membrane stretched over a plurality of electrostatic electrodes providing local controlled deformation to the membrane.

### STATEMENT REGARDING FEDERALLY SPONSORED RESEARCH OR DEVELOPMENT

This invention was made with United States government support awarded by the following agencies:

USAF/AFOSRFA9550-06-1-0487

The United States has certain rights in this invention.

### Background of the Invention

It is often desirable to image biological tissue through intervening tissue or structure, for example, through overlying light transmissive layers of cells (e.g., in the breast) or through fluids (e.g., the aqueous or vitreous humor in the eye). Imaging through intervening tissue or structure allows tissue to be studied in relatively thick sections or in vivo.

To a limited extent, such imaging of internal structures may be done using a conventional microscope by focusing the microscope objective “through” the overlying layers so that the structure of interest is at the focal plane of the microscope objective and sharply in focus and other overlying structures are defocused.

Confocal microscopy takes this process a step further by placing a light stop in the optical path to block all light not received from the single focal spot of the microscope objective. Scanning the focal spot through the tissue and measuring variations of brightness as a function of that scan can produce an image free from light interference from adjacent layers in the tissue. Unfortunately, the optical stop significantly limits the light through the confocal microscope, requiring a bright illuminating light source, usually provided by a laser, and long exposure times.

Recently developed techniques allow virtually any protein in a cell to be tagged with fluorescent molecules. The fluorescent molecules, and thus the tagged cells, can then be visualized by exciting the fluorescent molecule with an excitation light beam. The excitation beam is typically of a different frequency than the frequency of fluorescence so that a dichroic filter can be used to block the excitation beam, making the tagged tissue stand out.

Referring to FIG. 1, an improved variation on confocal microscopy makes use of this fluorescent tagging in a process called multi-photon fluorescence. In multi-photon fluorescence, a fluorescent molecule 10 may simultaneously absorb two (or more) photons 12 to move to an excited state 14 elevated by at least twice the energy of each individual photon 12. A subsequently emitted fluorescence 16 will have approximately twice the frequency of the stimulating photons 12 to be readily distinguishable from the photons 12 of the exciting beam. Importantly, the property of multi-photon fluorescence is nonlinearly related to light intensity and thus multi-photon fluorescence can be controlled to occur in only small regions where the excitation light beam is focused to an intensity causing significant multi-photon fluorescence. Tissue before and after this focused region, even if tagged by the fluorescent molecules, will exhibit only weak multi-photon fluorescence.

Referring to FIG. 2, a multi-photon microscope 20, exploiting this principle, typically employs a light source 22 and provides an excitation beam 23 of stimulating photons 12 which are then received by an optical assembly 24 which focuses the beam 23 at a focal plane 26 to a focal spot 30. As the beam 12 narrows with focusing, the intensity increases and the amount of multi-photon fluorescence 32 increases rapidly, causing the tissue to fluoresce principally only at the focal spot 30 in the focal plane 26. Light 35 from that fluorescence passes backward through the optical assembly 24 and is reflected off a dichroic mirror 36 separating it from an excitation beam 23 and allowing it to be received by a photodetector 38. The spot 30 is scanned through tissue in a three-dimensional raster pattern 40, and brightness values obtained by the photodetector 38 are mapped to the locations in the tissue to provide the ability to reconstruct images of embedded structures in the tissue free from the influence of underlying or overlying tissue.

Such multi-photon fluorescence techniques have been used to provide sharp images of in vivo tissue up to a depth of about 600 μm. Beyond this depth, the ability to provide a small focal spot 30 (which ultimately determines the resolution of the image) degrades because of inhomogeneities in the optical properties of the intervening tissue, principally refractive index, which distort the incident waveform, preventing sharp focus.

The principles of adaptive optics have been applied to correct the problem of wavefront distortion. Here the goal is to pre-distort the wavefront of the excitation beam to offset exactly the aberration caused by the intervening tissue. Such approaches may use deformable mirrors that have a continuous surface actively deformed to elevate or depress the surface locally and thereby to advance or retard portions of the wavefront reflected from that surface by precise amounts.

Some deformable mirrors use piezoelectric actuators below the mirror surface to produce the deformation. These designs can be costly and may not scale well to “high-resolution” mirrors requiring many discrete piezoelectric elements. This latter shortcoming can be addressed to some degree by an alternative design that replaces the piezoelectric elements with electrostatic actuators. Each electrostatic element comprises an electrode on a substrate covered by a separately movable actuation element spaced slightly above the electrode on the substrate. A voltage applied on the substrate electrode can be used to generate an electrostatic force on the movable element and displace the element. Discrete mirrors are attached to each actuation element and can be displaced by the movable element.

Integrated-circuit fabrication techniques allow this latter design to be scaled readily to a large number of mirrors. Nevertheless, the fabrication process is complicated and requires the deposition of layers of relatively thick polycrystalline material. Subsequent processing steps may be required to remove stresses from these layers that would distort the mirror, and the thickness of the actuation layers limits the actuation distance obtainable and thus the amount of optical correction that may be produced with the mirror. Thicker layers also have increased actuation delay that may affect the response speed of the mirror. Furthermore, deposited polycrystalline material, particularly thick layers, provides a relatively rough surface that is an undesirable optical surface.

### BRIEF SUMMARY OF THE INVENTION

The present invention provides a deformable mirror fabricated using a continuous and extremely thin monocrystalline membrane, preferably a silicon membrane. The membrane may be removed from a previously fabricated and polished SOI wafer, or directly removed from Si using a cleaving process, and then transferred to a substrate holding the electrodes of the electrostatic actuators. The thin, smooth, and continuous surface of the membrane can (in one embodiment) provide both the reflective layer and the actuation elements, offering an extremely simple structure capable of fast response, high compliance, low distortion, and good reflectivity.

Specifically, the present invention provides a deformable mirror having a frame providing a peripheral ridge surrounding a backplate recessed below the ridge. A plurality of electrodes are arrayed on the surface of the backplate to individually receive a voltage and a unitary membrane is attached to the peripheral ridge to span the plurality of electrodes without contacting the backplate, so that the membrane may be locally deformed by an electrostatic field applied to at least one electrode. The outer surface of the unitary membrane has a mirror surface, either formed by the unitary membrane itself or attached thereto.

It is thus an object of one embodiment of the present invention to provide a deformable mirror having an extremely simple structure that may be easily manufactured and readily scaled to many actuating elements. It is another object to provide a continuous mirror surface such as may provide better waveform correction in some applications.

The membrane may have a thickness of less than 2 μm.

An object of one embodiment of the invention is that it provides a thin mirror with extremely low areal mass and small bending stiffness, permitting large actuation amounts, fast actuation, and higher spatial frequency of deformation.

The membrane may be a silicon membrane.

An object of this embodiment of the invention is that it provides a membrane material compatible with integrated-circuit processing techniques.

The membrane may be a monocrystalline membrane.

It is thus an object of an embodiment of the invention to provide a membrane having low residual stress and high flatness.

The membrane, when undeformed by an electrostatic field, may have opposed substantially planar surfaces.

It is thus an object of one embodiment of the invention to make use of a simple membrane without the need for additional structures such as posts or spacers on its surface and thus that may be more easily fabricated.

The membrane and the frame may be constructed of materials that have a matched coefficient of thermal expansion.

It is thus another object of an embodiment of the invention to permit an edge-suspended membrane that works over a range of operating temperatures.

The reflective surface may be an applied reflective material, such as a metal layer.

Thus it is an object of an embodiment of the invention to permit tailoring the reflective surface to arbitrary wavelengths of light, for example, by using gold for infrared reflection.

The applied reflective material may be placed symmetrically on the outer and inner surface of the unitary membrane.

It is thus an object of an embodiment of the invention to provide a reflective surface without introducing unbalanced stresses that may warp the membrane.

The outer reflective surface may be a Bragg mirror.

It is thus an object of an embodiment of the invention to provide a reflective surface that may be realized completely with alternating layers of semiconductor material.

The invention may include a control circuit communicating with the electrodes and a light sensor to provide wavefront correction in an adaptive-optics system.

It is thus an object of an embodiment of the invention to provide an improved mirror for adaptive optics.

The mirror may be manufactured by separating the unitary membrane from a supporting wafer and attaching the unitary membrane to the ridge. The step of attaching the unitary membrane to the ridge may occur before or after separation of the unitary membrane from the supporting wafer.

It is thus an object of an embodiment of the invention to provide a simple method of producing extremely thin membranes for a deformable mirror.

The invention may be used as a component in a multiphoton fluorescence microscope having a light source for producing a beam of light promoting multiphoton fluorescence in an object to be imaged. The deformable mirror may receive the beam of light and shift the phase of the beam by different amounts in different portions of a cross-sectional area of the beam according to a control signal. An optical system may focus the beam of light to a focal spot within the object to be imaged, the object to be imaged having varying optical properties. A control system communicating with the deformable mirror may control the shifting of the phase of the beam to correct for the varying optical properties of the object to be imaged.

It is thus an object of an embodiment of the invention to provide an improved multiphoton microscope.

These particular features and advantages may apply to only some embodiments falling within the claims and thus do not define the scope of the invention.

### BRIEF DESCRIPTION OF THE DRAWINGS

FIG. 1 is an electron energy diagram illustrating the principle of multi-photon fluorescence;

FIG. 2 is a block diagram of an existing multi-photon fluorescence microscope showing the optical path of light through tissue as aligned with a plot of multiphoton fluorescence versus distance along the optical axis;

FIG. 3 is a block diagram similar to that of FIG. 2 showing a multi-photon fluorescence microscope employing the deformable mirror of the present invention;

FIG. 4 is a fragmentary side elevational view of the deformable mirror of FIG. 3;

FIG. 5 is a fragmentary cross-section of the deformable mirror of FIG. 4 in a first embodiment showing metallization of the front and back surfaces of the mirror membrane;

FIG. 6 is a fragmentary cross-section of the deformable mirror of FIG. 4 in a second embodiment showing formation of a Bragg mirror to create a reflective surface of the membrane;

FIG. 7 is a cross-sectional view of a step in one process for fabricating the mirror of FIG. 4 in which the membrane is bonded to a tray and then released from a supporting substrate;

FIG. 8a and FIG. 8b are simplified representations of an excitation light beam directed into biological tissue showing, in FIG. 8a, distortion of the wavefront by the varying refractive indexes of the tissue which prevents a high-intensity focal spot and, in FIG. 8b, compensation of the waveform to produce a high-intensity focal spot;

FIG. 9 is a flow chart of a phase correction process using the present invention;

FIG. 10 is a fragmentary block diagram similar to FIG. 3 showing an alternative embodiment using a wavefront detector; and

FIG. 11 is a flow chart showing use of the system of FIG. 3 or 10 for laser surgery.

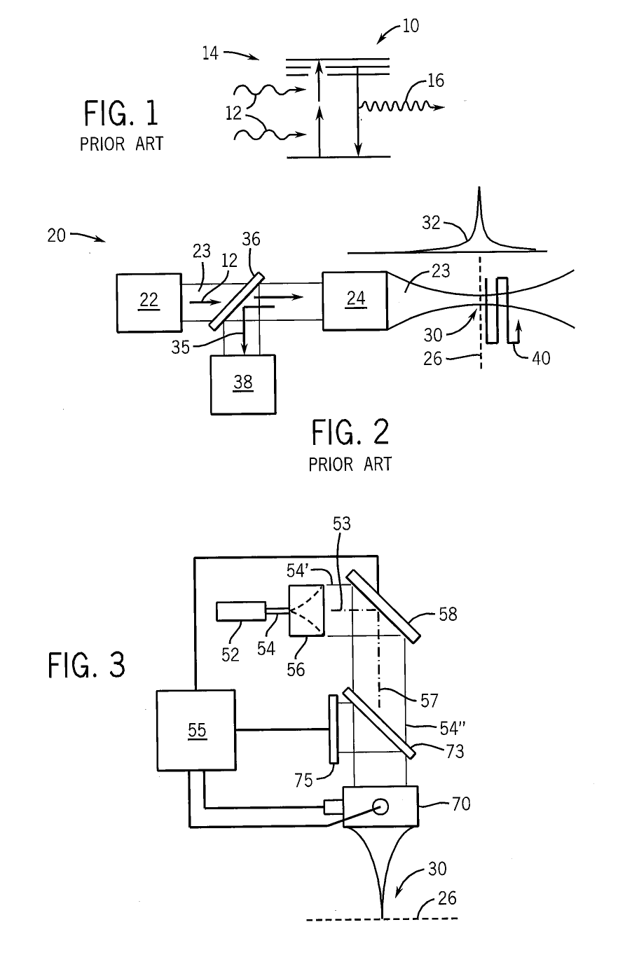

### DETAILED DESCRIPTION OF THE INVENTION

Referring now to FIG. 3, in an example application, a deformable mirror 58 of the present invention may be used in a scanning optical microscope 50 having a laser light source 52 directing a beam 54 toward a beam expander 56. The beam expander 56 increases the area of the beam 54 to enlarged beam 54′ sized generally to direct the light along axis 53 to illuminate an active area of a deformable mirror 58 angled with respect to axis 53 to reflect light along axis 57.

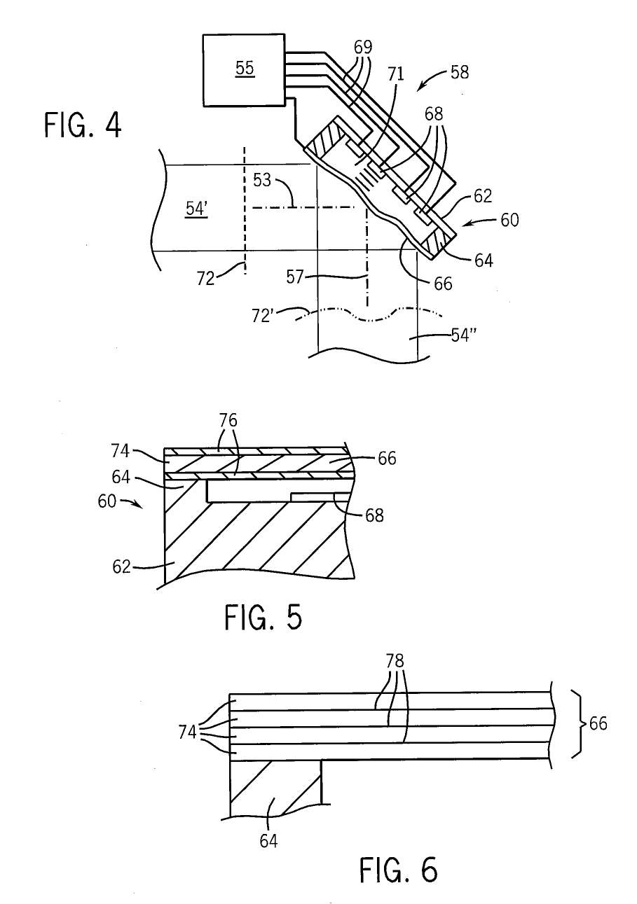

Referring to FIG. 4, the deformable mirror may provide for a tray 60 having a backplate 62 surrounded by a peripheral ridge 64 extending away from a front surface of the backplate 62. A thin, flexible membrane 66 may be attached at its edges to the peripheral ridge 64 to cover the tray 60 in front of the front surface of the backplate 62.

The front surface of the backplate 62 may have a plurality of electrically isolated electrodes 68, for example, arranged in rectilinear rows and columns. The electrodes 68 may be, for example, metallized areas formed using integrated-circuit techniques and may communicate each with a unique conductive lead 69, as shown, or with a multiplexing circuit (not shown), for example, using transistor switches and a row-column addressing system or other technique known in the art of producing addressable arrays such as memory cells or flat panel displays.

A computerized control system 55 may provide independent voltages (relative to a voltage applied to the membrane 66) to each of the electrodes 68 via leads 69 to create a series of electrostatic actuators. In operation, electrostatic attraction 71 between individual electrodes 68 and a portion of the membrane 66 immediately opposed to the electrode 68 locally deforms a front surface of the membrane 66 as a function of the voltage applied to the electrode 68.

The front surface of the membrane 66 is reflective so that the beam 54′ from the beam expander 56, having a (generally spherical) wavefront 72, may be received and reflected off the front surface the deformable mirror 58 and phase shifted at different portions of the cross-section of the beam 54′ according to the local deflection of the membrane 66 by the electrostatic actuators. This phase shifting creates a new distorted wavefront 72′ in beam 54″. The amount of phase shift will depend on the frequency of light and the local displacement of the surface of the membrane 66. The high compliance of the membrane 66 should allow the membrane 66 to be displaced by more than one wavelength at the frequencies of interest, allowing sufficient correction for the substantial phase shift that can be created in thick biological tissues.

Referring now to FIG. 5, the membrane 66 is preferably a monocrystalline silicon layer 74 having a thickness of less than 2 μm and possibly as thin as 10 to 20 nm. A front surface of the membrane 66 may be metallized, for example, with a thin vacuum deposited gold layer 76 to provide a desired reflectivity at a wavelength of interest. In this case, a back side of the membrane 66 may also have an applied gold layer 76 to provide for symmetrical mechanical properties and to compensate for thermal stresses or the like and avoid undesirable curvature of the membrane.

The tray 60, including the peripheral ridge 64 and backplate 62, may be constructed of the same material as the membrane 66 (e.g., silicon) for example, by etching both the backplate 62 and peripheral ridge 64 from a single silicon wafer, to provide identical thermal expansion between the tray 60 and the membrane 66, preventing a change of tension of the membrane 66 with changes in operating temperature.

Referring now to FIG. 6, in an alternative embodiment, the membrane 66 may be formed of multiple monocrystalline silicon layers 74 separated by thin layers of material 78 having a different index of refraction, for example, silicon dioxide, to create a Bragg mirror where reflection is the result of constructive interference of partial reflections of light at each interface between the multiple monocrystalline silicon layers 74. The Bragg mirror eliminates the need for metallization and allows the back surface of the membrane 66 to be oxidized so that a layer of silicon dioxide can be used to attach the membrane 66 to the ridges 64 by a fusing process.

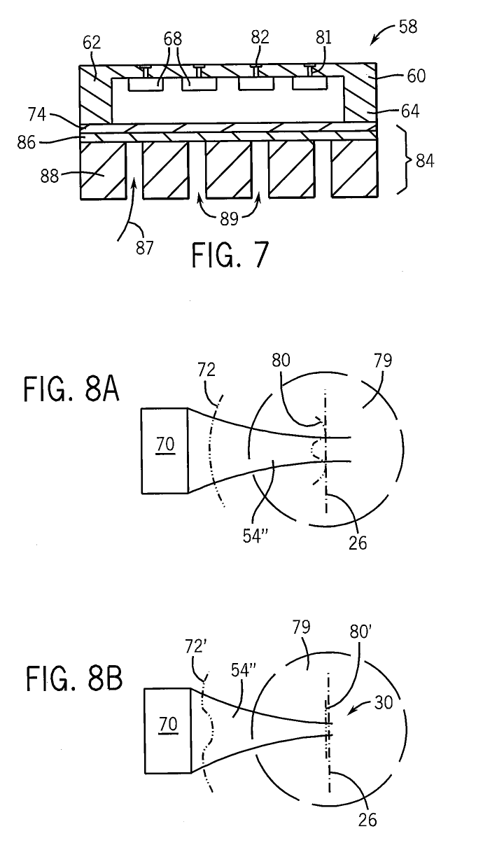

Referring now to FIG. 7, the deformable mirror 58 of the present invention may be manufactured by separately fabricating the membrane 66 (for example by detaching it from a supporting substrate) and then moving it as a membrane to the tray 60 for attachment. This fabrication of the membrane 66 is described in more detail in U.S. Pat. No. 7,229,901 issued Jun. 12, 2007 and entitled: “Fabrication of Silicon/Silicon-Germanium Heterojunction Structures” to M. R. Roberts, D. E. Savage, and M. G. Lagally, assigned to the assignee of the present invention

Alternatively, the membrane 66 may be held on its substrate until after attachment to the tray 60. In this latter process, a tray 60 is constructed of a unitary monocrystalline substrate etched to provide the ridge 64 surrounding a backplate 62. Standard masking and metallization techniques may then be used to apply the electrodes 68, for example, over conductive vias 81 joining each electrode 68 with a transistor switch 82 on the rear side of the backplate 62. Both the vias 81 and transistor switches 82 may be fabricated by conventional integrated-circuit techniques.

Upon completion of the tray 60, a silicon-on-insulator (SOI) wafer 84 may be bonded to the peripheral ridges 64 to cover the tray 60. The SOI wafer 84 includes a thin monocrystalline silicon layer 74 on its front face that may face the backplate 62 of the tray 60 as bonded.

The monocrystalline silicon layer 74 of the SOI wafer 84 may be then separated from the silicon substrate 88 by a selective etching to remove the oxide layer 86, for example, by irrigation with hydrofluoric acid etchant 87. To facilitate this separation of the monocrystalline silicon layer 74, a pattern of holes 89 may be etched in the silicon substrate 88 to provide improved access for the hydrofluoric acid etchant 87.

SOI wafers 84 are used widely in the integrated-circuit industry and provide a monocrystalline silicon layer 74 on top of an oxide layer 86 that in turn is supported by a bulk silicon substrate 88. SOI wafers 84 may be manufactured by a variety of processes, for example by ion beam implantation of oxygen into a single crystal silicon substrate 88 to form a buried oxide layer 86. Alternatively, the SOI wafer 84 may be created by bonding of a second silicon wafer to a silicon substrate 88 by means of an intervening oxide layer 86. The second silicon wafer is then thinned to produce the upper monocrystalline silicon layer 74 of the SOI wafer 84.

Thinning of the upper monocrystalline silicon layer 74 to form the SOI wafer with a membrane 66 of the desired thickness may be done by grinding and polishing or by using the so-called “Smart Cut” method in which the upper monocrystalline silicon layer 74 is fractured along a line of bubbles near the oxide layer 86, the bubbles created by annealing after hydrogen implantation. This technique is described generally in U.S. Pat. No. 6,372,609 to Aga et al. entitled: Method of Fabricating SOI Wafer by Hydrogen Ion Delamination Method and SOI Wafer Fabricated by the Method, issued Apr. 16, 2002 and hereby incorporated by reference. Thinning of the upper monocrystalline silicon layer 74 may be done by oxidation of the exposed surface of the upper monocrystalline silicon layer 74 to create silicon dioxide and the eroding of the silicon dioxide layer with hydrofluoric acid. Alternatively, the upper monocrystalline silicon layer 74 of the SOI wafer 84 may be mechanically ground and polished.

The monocrystalline silicon layer 74 is mechanically separated from the silicon substrate 88 to provide a nanoscale membrane 41 having extremely smooth faces and a monocrystalline structure with few defects by etching the oxide.

Referring again to FIG. 3, the beam 54′, after being reflected off of the mirror 58 of the present invention, is received by the objective lens/scanning system 70 which focuses the beam 54 to a focal spot 30 in focal plane 26. Deformable mirror 58 can be positioned at a conjugate plane of the objective lens/scanning system 70 on a backside of the objective lens/scanning system 70 to be readily retrofit to a number of existing multi-photon microscopes providing the objective lens/scanning system 70.

The focal plane 26 may be scanned in depth and the focal spot scanned in two dimensions within the focal plane 26, by known optical or mechanical means, to provide for a three dimensional scanning of the focal spot 30 within tissue. At each location of the focal spot 30, light fluorescing from the focal spot 30 may pass back through the objective lens/scanning system 70 along axis 57 to be received by a dichroic mirror 73 passing light of the frequency of beam 54′ and diverting only light fluorescently generated by the tissue at the focal spot 30 to a photodetector 75.

A computerized control system 55 executing a stored program may control the deformable mirror 58 based on signals from the photodetector 75 as will be described below.

Referring now to FIGS. 3, 4 and 8a, when electrodes 68 are energized (providing no phase shifting of the beam 54′), the objective lens/scanning system 70 will produce a wavefront 77 that, absent refractive effects of tissue 79, would produce a planar wavefront focusing at focal plane 26. Refractive effects of intervening tissue 79, however, distort the wavefront 72′ to wavefront 80 at the focal plane 26, the wavefront 80 being sufficiently distorted to prevent the formation of a compact focal spot 30 with high photon density sufficient to produce sufficient multi-photon fluorescence.

Referring to FIG. 8b, in the present invention, the deformable mirror 58 is operated to produce a pre-distorted wavefront 72′ that, when conversely distorted by the intervening tissue 79, results in a planar wavefront 80′ converging at a point at the focal plane 26 producing a high intensity at focal spot 30 of small area and suitable to establish a high resolution multi-photon fluorescent activity.

If the properties of the tissue 79 are known, the exact amount of phase shift for different portions of the cross-sectional area of beam 54′ may be readily determined and implemented by the deformable mirror 58 with the computerized control system 55 producing the necessary driving signals for the electrodes 68. When tissue 79 is not well-characterized, it may be approximated or its properties may be modeled and tested to produce diffraction patterns according to this general strategy.

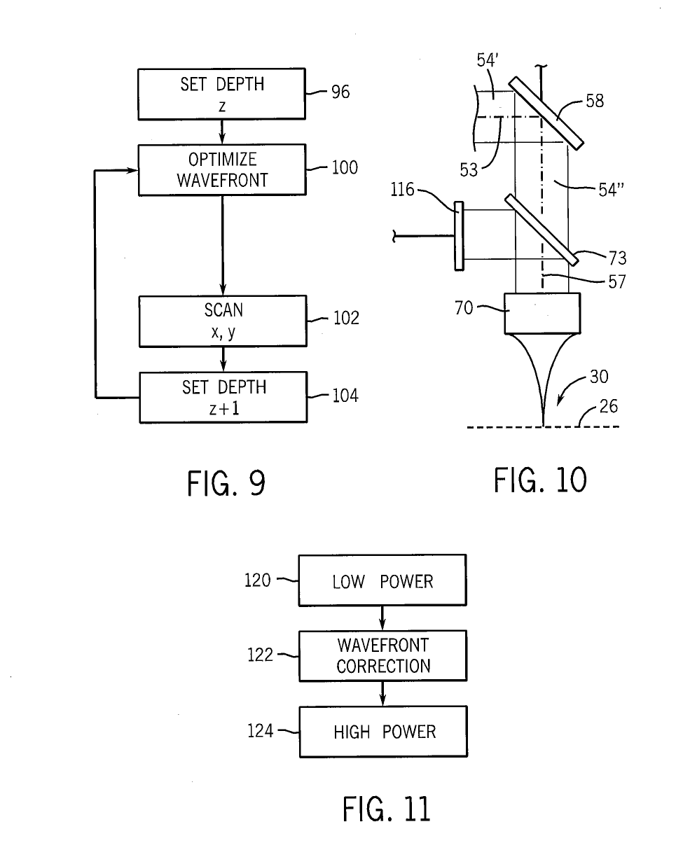

More typically, an iterative determination of the necessary diffraction pattern to be produced by the deformable mirror 58 will be employed. Referring to FIG. 9, in such an iterative approach, at process block 96, the objective lens/scanning system 70 will be set by the computerized control system 55 to “park” the focal spot 30 at a point in the tissue 79. The computerized control system 55 will then adjust the deformable mirror 58 to maximize the brightness detected by photodetector 75 such as generally indicates proper convergence of the phases of the beam 54. In one embodiment, this first measurement may be at a very shallow depth where no correction is required or very little correction is required so that optimized determination of the mirror settings may be produced quickly by well known “hill-climbing” techniques, such as simulated annealing or Monte Carlo processes, per process block 100.

At process block 102, the focal spot may be scanned in the x-y plane at this z depth, (making an assumption of constant aberration at a given depth) or with limited fine adjustments per process block 100 repeated at each scan point.

At process block 104, after the focal plane 26 is scanned, the focal spot may be parked at a greater depth (e.g., at a deeper focal plane 26) and this process repeated. Preferably, for each focal plane 26, the process of process block 100 begins with the coefficients previously established at the preceding focal plane 26, further reducing the amount of iteration required.

Similarly it may be possible to pre-characterize the aberration at various points in the tissue and then to use those aberration samples as a starter point for limited iteration on the tissue at a later time.

Referring to FIG. 10, in an alternative embodiment, the photodetector 75 may be replaced with a wavefront detector 116, such as a Shack-Hartmann sensor detecting local tilt of the wavefront as received from the from the focal spot 30. The actual wavefront from the focal spot 30 may thus be approximated by a piecewise fitting of the detected slopes of the wavefront to allow correction of the beam 54″ by deformable mirror 58 without iteration or with reduced iteration.

Generally the present invention is not limited to use in a multiphoton microscope but may also find use in a regular or confocal microscope or in a scanning optical microscope employed for laser surgery, for example, of the retina. In this case the objective lens/scanning system 70 is used to manipulate the focal spot 30 of the laser to the desired depth and location for the surgery. The laser light source may be first operated in a low-power mode illuminating the focal spot without significant heating of the tissue to allow for iterative correction of the wavefront as was described above. When the focal spot has been minimized by wavefront correction to a sufficient degree, the laser light source is pulsed at a high power to provide for surgical heating of tissue at the focal spot.

The present invention has been described in terms of the preferred embodiment, and it is recognized that equivalents, alternatives, and modifications, aside from those expressly stated, are possible and within the scope of the appending claims.

1. A deformable mirror comprising:
a frame providing a peripheral ridge surrounding a backplate recessed below the ridge;
a plurality of electrodes arrayed on a surface of the backplate to individually receive a signal and apply a voltage;
a unitary membrane attached to the peripheral ridge to span the plurality of electrodes without contacting the backplate, and to be locally deformed by an electrostatic field applied to at least one electrode, an outer surface of the unitary membrane having a mirror surface.

2. The deformable mirror of claim 1 wherein the membrane has a thickness of less than 2 μm.

3. The deformable mirror of claim 1 wherein the membrane is a silicon membrane.

4. The deformable mirror of claim 1 wherein the membrane is a monocrystalline membrane.

5. The deformable mirror of claim 1 wherein the membrane when undeformed by an electrostatic field has opposed substantially planar surfaces.

6. The deformable mirror of claim 1 wherein the mirror surface is an applied reflective element.

7. The deformable mirror of claim 6 wherein the applied reflective material is placed symmetrically on the outer and inner surface of the unitary membrane.

8. The deformable mirror of claim 1 wherein the membrane and the frame have matched coefficient of thermal expansion.

9. The deformable mirror of claim 1 wherein the mirror surface is a metal layer.

10. The deformable mirror of claim 1 wherein the outer mirror surface is a Bragg mirror.

11. The deformable mirror of claim 1 further including a control circuit communicating with the electrodes and a light sensor to provide wavefront correction in an adaptive optics system.

12. A method of fabricating the deformable mirror of claim 1 comprising the steps of:
separating the unitary membrane from a supporting wafer; and
attaching the unitary membrane to the ridge.

13. The method of claim 12 wherein the step of attaching the unitary membrane to the ridge occurs prior to separation of the unitary membrane from the supporting wafer.

14. A multiphoton fluorescence microscope comprising:
a light source for producing a beam of light promoting multiphoton fluorescence in an object to be imaged;
a deformable mirror for receiving a beam of light and shifting a wavefront of the beam by different amounts in different portions of a cross-sectional area of the beam according to a control signal;
an optical system focusing the beam of light to a focal spot within the object to be imaged, the object to be imaged having varying optical properties;
a control system communicating with the deformable mirror to control the shifting of a phase of the beam to correct for the varying optical properties of the object to be imaged;
wherein the deformable mirror includes:
a frame providing a peripheral ridge surrounding a backplate recessed below the ridge;
a plurality of electrodes arrayed on a surface of the backplate to individually receive a voltage;
a unitary membrane attached to the peripheral ridge to span the plurality of electrodes without contacting the backplate to be locally deformed by an electrostatic field applied to at least one electrode; and
an outer surface of the unitary membrane being reflective.
